(19) United States
(12) Patent Application Publication
(10) Pub. No.: US 2004/0037318 A1
(43) Pub. Date: Feb. 26, 2004

(54) Transmitting address data in a protocol stack

(76) Inventors: Hannu-Pekka Salin, Vantaa (FI); Teemu Makinen, Jarvenpaa (FI); Kari Einamo, Espoo (FI); Sami Kekki, Helsinki (FI); Seppo Huotari, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/381,194

(22) PCT Filed: Sep. 20, 2001
(86) PCT No.: PCT/FI01/00820

(30) Foreign Application Priority Data
Sep. 22, 2000 (FI) 20002093

(51) Int. Cl. H04J 3/16

(52) U.S. Cl. 370/469; 370/465

(57) ABSTRACT

When an SCCP protocol according to the SS7 signalling system is used in the network layer and some other protocol than a protocol according to the SS7 signalling system is used in the lower layer, an address according to the second system is set as a proper address in the address field of the addressing according to the SCCP protocol, the address is marked as a global title address of the SCCP protocol, and the proper address is transmitted from the first layer to the second layer. In this way the lower layer receives an address it can use for routing and there is no need to change the addressing of the SCCP protocol.

### BACKGROUND OF THE INVENTION

The invention relates to making the addressing of the network layer of an SCCP (Signalling Connection Control Part) protocol designed for a circuit-switched network compatible with the addressing used in an IP (Internet Protocol) network.

Mobile systems have been developed, because there is a need to allow people to move away from their fixed telephones without affecting their accessibility. A mobile system refers generally to any telecommunications system which uses wireless traffic when users move within the service area of the system. A typical mobile system is the PLMN (Public Land Mobile Network).

Mobile systems are developed continuously and one of the main objectives is to provide a possibility to use IP services through the mobile system. Correspondingly, IP technology is developing to cover the conventional services of mobile systems, such as telephony. These two technologies have been combined in the 3GPP AII-IP system. It is a UMTS (Universal Mobile Telecommunication System) system based on the IP technology defined in the co-operation project of what are known as a third-generation mobile systems, 3GPP (3^{rd} Generation Partnership Project). The 3GPP AII-IP system is a biplane system comprising an application layer providing services and a transport layer providing data transfer. At least in the beginning the pan-European GSM system (Global System for Mobile Communications) and especially the services of what is known as the GSM 2+ phase, such as the GPRS (General Packet Radio Service), are utilized in the transport layer.

Information specific to the mobile network, for instance, is transmitted using the protocols of the signalling system SS7 (Signalling System #7) in the interfaces of the GSM system. The various protocols use the services of the SCCP protocol of the SS7 of the network layer in routing. Some 3GPP AII-IP system interfaces also use protocols which use the SCCP for routing. The problem is, however, that these protocols cannot directly use an IP address for transferring and transmitting signalling, because the SCCP can only use two types of addressing. The types are ‘route on GT’ and ‘route on SSN’. ‘Route on GT’ means that a global title GT is used for routing. ‘Route on SSN’ means that a subsystem number SSN and a signalling point code SPC in the MTP routing label are used for routing. A GT address consists of numbers of the address and side information indicating what kind of an address (number) is in question. The side information of the GT address according to ETSI comprises a numbering plan, a type of the number and translation type. The side information of the GT address according to ANSI comprises translation type.

In general, GSM networks use the E.164 numbering plan. Other possible numbering plans are the E-212 and E.214. In the GT address according to ANSI, translation types corresponding to numbering plans E.164 and E.212 are used. For lower-level protocols, the GT addresses are translated into SPC values with GT translation when routing using a GT address. Because the SCCP does not recognise an IP address and cannot transmit it, each IP network signalling node transmitting the SCCP and/or higher-level protocols using the SCCP should have a GTaddress and an IP address. In the 3GPP AII-IP network, translating one address into another is done by the R-SGW (roaming signalling gateway). Reserving two different addresses to all network nodes participating in the IP network signalling and transmitting the IP-network signalling is completely unnecessary and needlessly uses up both address spaces. In addition, it is simplier to use the IP address in addressing between two IP network nodes, even when they transmit the SCCP and/or higher-level protocols using the SCCP.

### BRIEF DESCRIPTION OF THE INVENTION

It is thus an object of the invention to provide a method and equipment implementing the method so as to solve the above-mentioned problems.

The object of the invention is achieved by a method for transmitting address information in a telecommunications system protocol stack comprising at least a first layer which comprises an SCCP layer which uses an SCCP protocol according to the SS7 signalling system and a second layer below the first layer, which uses a second protocol according to a second system, the method being characterized by comprising the following steps of setting an address according to the second system as a proper address in the address field of the addressing according to the SCCP protocol and marking the address as a global title address of the SCCP protocol, and transmitting the proper address from the first layer to the second layer.

The invention further relates to a network node which is arranged to use an SCCP protocol according to the SS7 signalling system in the network layer and to use below the network layer at least a second protocol according to a second system, the network node being characterized in that it is arranged to use in the SCCP protocol addressing an address according to the second system as an SCCP protocol global title address and to transmit to the second protocol, the address according to the second system.

The invention is based on the idea that an IP address is treated as a GT address in the SCCP protocol (and higher-level protocols), but the IP address is transmitted instead of the SPC to layers below the network layer. The invention provides the advantage that by slightly modifying the existing protocol definitions, it is possible to use the IP address in transferring signalling in layers below the network layer without changing the structure of the address used by the SCCP and which it transmits to the upper layers. The invention also provides the advantage that there is no need to give two different addresses to the IP network nodes, thus using up address spaces needlessly. This also avoids any unnecessary load of the signalling gateway for instance due to changing the IP address into the E.164 address when the IP address is sufficient.

Preferred embodiments of the method and network node of the invention are disclosed in the attached dependent claims.

### BRIEF DESCRIPTION OF THE DRAWINGS

In the following, the invention will be described by means of the preferred embodiments with reference to the attached drawings in which

FIG. 1 shows a first SCCP protocol stack according to the invention,

FIG. 2 shows information transmission in the first SCCP protocol stack,

FIG. 3 shows a second SCCP protocol stack according to the invention,

FIG. 4 shows information transmission in the second SCCP protocol stack,

FIG. 5 shows information transmission in a third SCCP protocol stack, and

FIG. 6 shows a simplified block diagram of a system according to the first preferred embodiment of the invention.

### DETAILED DESCRIPTION OF THE INVENTION

The present invention can be applied to any telecommunications system in which the SCCP and/or higher-level protocols using the SCCP are transmitted by means of some other protocol than the SS7 system protocol. These include third-generation mobile systems, such as the UMTS and IS-41 and systems based on the GSM system, such as the GSM 2+ systems and systems corresponding to them. Corresponding mobile systems include the GSM 1800 and PCS (Personal Communication System). The invention can also be applied to fixed systems, for example in the IN interface of the fixed networks. In the following, the invention will be described using the 3GPP AII-IP system as an example, without, however, restricting the invention thereto. In addition to the SS7 protocols, the 3GPP AII-IP system uses the IP protocol for transferring signalling. The specifications of mobile systems and especially third-generation mobile systems develop quickly. This development may require extra changes to the invention. Therefore, all terms and expressions should be interpreted widely and are only intended to describe and not restrict the invention.

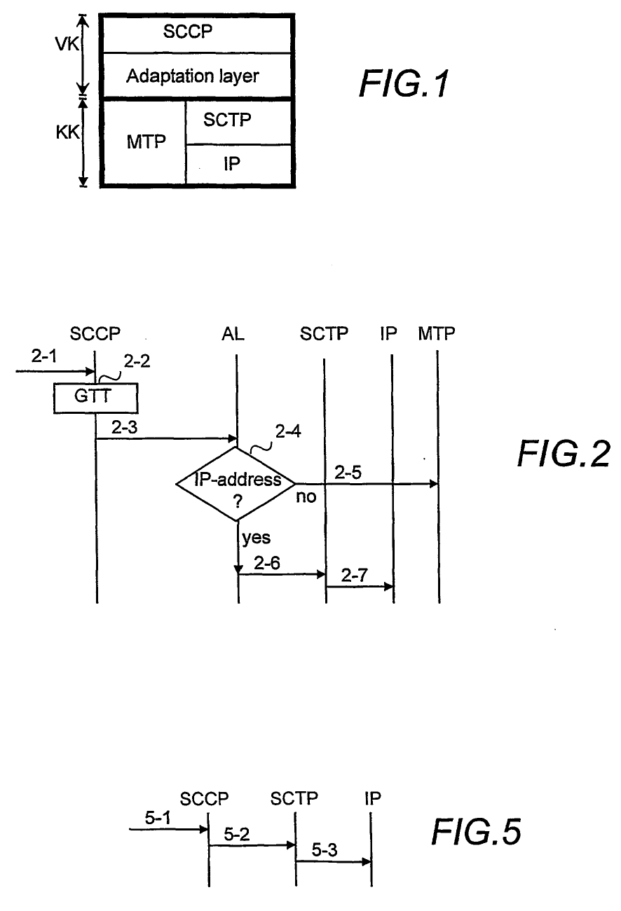

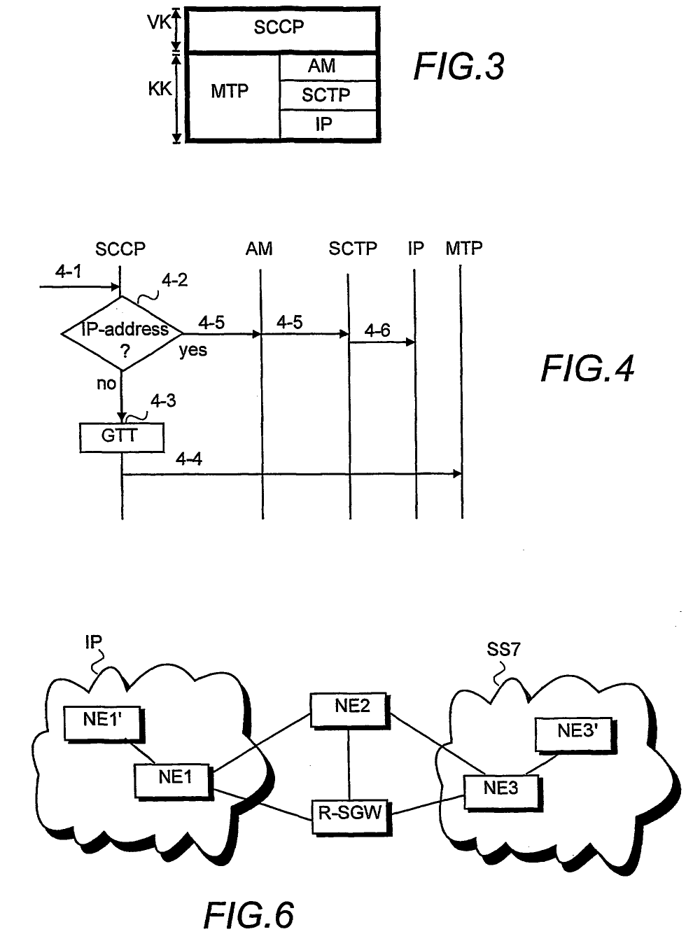

FIGS. 1 and 3 only show an SCCP protocol stack. The protocol stacks shown in FIGS. 1 and 3 can be part of a MAP (Mobile Application Part) protocol stack, in which case a TCAP (Transaction Capabilities Application Part) and a MAP layer would exist on top of the SCCP protocol stack. Other examples are the CAP (CAMEL Application Part) protocol and the RANAP (Radio Access Network Adaptation Protocol). The CAP protocol stack differs from the MAP protocol stack in that there is a CAP layer instead of the MAP layer. In the RANAP protocol stack, the RANAP layer is directly on top of the SCCP protocol stack. The protocol stacks shown in FIGS. 1 and 3 comprise both an SS7 stack and an IP stack. The protocol stacks shown in FIGS. 1 and 3 can also be implemented so that they only comprise either the IP stack or the SS7 stack.

It is not expressed in FIGS. 1-4 how the layers in the SCCP layer handle different addresses, because it is not relevant to the Invention. Information on the address type is usually received from an application on the protocol stack, a user of the MAP protocol, for instance.

FIG. 1 shows a first SCCP protocol stack of the invention, later referred to as the first protocol.

In the first protocol, a network layer VK comprises two sub-layers: an SCCP layer and below it, an adaptation layer AL which selects between an SS7 and an IP stack. In a layer KK below the network layer, an MTP protocol (Message Transfer Part), which uses an SPC value in addressing, handles signalling transmission in the SS7 stack, whereas in the IP stack, signalling transmission is handled by an SCTP (Stream Control Transmission Protocol) and IP which uses IP address as a routing address.

In the first protocol, ‘IP address’ is defined as a new numbering plan for the GT address of the SCCP layer. When routing using the IP address is needed, the IP address is entered in the place reserved for the actual routing address and an indication is provided that this is a GT address which uses a numbering plan whose type is ‘IP address’. In other words, the structure of the SCCP address need not be changed. A new value is only used in the field indicating the numbering plan. This new value makes it possible to distinguish the IP addresses from the prior art GT addresses in a GT translation in the first protocol according to the invention, and to thus control the end result of the GT translation. The actual SCCP layer and the layers above the SCCP which need not know anything about the address type thus do not even know they are processing an IP address, because it is disguised as a GT address. Thus, in the first protocol one does not have to change the actual SCCP, it is sufficient that the functionality of the adaptation layer is modified.

The operation of the first protocol in the first preferred embodiment of the invention is illustrated in FIG. 2 which shows information transmission in the first protocol stack from the top downwards. For clarity's sake, the figure does not mention the header information and the like added by each layer to the received information.

FIG. 2 starts from the SCCP receiving information 2-1 which indicates that the GT address is to be used in routing. In response to information 2-1, the SCCP performs the GT translation GTT according to prior art. The GT translation does not usually modify the GT address, but analyzes it in order to obtain the SPC. After this, the SCCP transmits in information 2-3 to the adaptation layer AL an address which preferably contains the GT address, information on the numbering plan used and an SPC value.

In step 2-4 the adaptation layer AL checks from the received information 2-3 whether the address to be used is an IP address. In the first preferred embodiment of the invention, the adaptation layer identifies the IP address from the value of the numbering plan used, for instance, or from the SPC value obtained as a result of the GT translation. If the address is not an IP address, the adaptation layer AL transmits the SPC value to the MTP in information 2-5. If the address is an IP address, the adaptation layer AL transmits the IP address in information 2-6 to the SCTP which forwards it to the IP in information 2-7. In other words, the adaptation layer selects between the SS7 and IP stack, i.e. selects the network through which the message will be transmitted.

If the first protocol is implemented only with the IP stack, in point 2-4 an error situation is detected if the address is not an IP address and information 2-5 will not be transmitted.

Correspondingly, if the first protocol is implemented only with the SS7 stack, in point 2-4 an error situation is detected if the address is an IP address and informations 2-6 and 2-7 will not be transmitted.

FIG. 3 shows a second SCCP protocol stack of the invention, later referred to as the second protocol. In the second protocol, the network layer VK comprises the SCCP layer and in the layer KK below the network layer the MTP handles signalling transmission in the SS7 stack, and the IP stack comprises an adaptation module AM and the SCTP and IP layers handling signalling transfer. The adaptation module between the SCCP and the SCTP layers is not necessary to the functionality according to the second protocol, since the second protocol does not cause changes to the functionality of the adaptation module. The adaptation module AM can be leftout/omitted, if the lower interface of the SCCP and/or the upper interface of the SCTP is modified so that there is no need to adapt them together. The IP stack under the network layer can be called a signalling transport layer.

Prior to the GT translation the SCCP according to the second protocol checks whether the address is an IP address and if it is, the SCCP does not perform the GT translation, but transmits the actual GT address as such direct to the adaptation module to be forwarded to the SCTP and IP. The SCCP according to the second protocol identifies the IP address from the value of the numbering plan used. Also other separators, with which the IP addresses can be separated from the prior art GT addresses, can be used. Examples of such separators are a nature of address indicator (NAI) and a translation type (TT). With the separator it is ensured that the selection of the routing network can be controlled and the GT translation can be skipped over when it is not needed.

If the SCCP uses the numbering plan to identify the IP address, a new numbering plan ‘IP address’ is defined for the GT address in the SCCP protocol also in the second protocol.

The second protocol provides the advantage that a GT translation is not performed unnecessarily to the IP addresses and there is no need to reserve SPC values for the IP addresses. The structure of the SCCP address need not be changed in the second protocol, either, but the SCCP is modified to directly transmit the actual GT address to a lower layer when the numbering plan (or some other corresponding separator) indicates that the GT address is an IP address. For the layers above the layer containing the SCCP protocol, the IP address is disguised as a GT-type address.

The operation of the second protocol in the second preferred embodiment of the invention is illustrated in FIG. 4 which shows information transmission in the second protocol stack from the top downwards. For clarity's sake, the figure does not mention the header information and the like added by each layer to the received information.

FIG. 4 starts from the SCCP receiving information 4-1 which indicates to route using the GT address. In response to information 4-1, the SCCP checks in step 4-2 whether the address to be used is an IP address. In the second preferred embodiment of the invention, the SCCP identifies the IP address from the value of the numbering plan used, for instance. If the address is not an IP address, the SCCP performs the GT translation GTT according to prior art in point 4-3 and transmits in information 4-4 to the MTP information, which preferably contains the GT address, on the numbering plan used and an SPC value.

If the address is an IP address, the SCCP transmits via the adaptation module AM the actual GT address (i.e. theIP address) in information 4-5 to the SCTP which forwards it to the IP in information 4-6.

The second protocol differs from the first protocol in that the SCCP layer does not perform the GT translation but transfers the GT address (via adaptation module) directly to the SCTP when the numbering plan (or some other separator) indicates that the GT address is an IP address. Further in the second protocol, the SCCP selects between the SS7 and IP stack, i.e. selects the network through which the message will be transmitted.

If the second protocol is implemented only with the IP stack, in point 4-2 an error situation is detected if the address is not an IP address, in which case the GT translation is not performed in point 4-3 and information 4-4 will not be transmitted.

Correspondingly, if the first protocol is implemented only with the SS7 stack, in point 2-4 an error situation is detected if the address is an IP address, and informations 2-6 and 2-7 will not be transmitted.

The third protocol according to the invention is intended for signalling transferred within an IP network only according to the IP technology. The third protocol stack is later referred as the third protocol. The third protocol is a single stack protocol and it comprises the SCCP, the SCTP and the IP layers and possibly the adaptation module between the SCCP and the SCTP. The operation of the third protocol is illustrated in FIG. 5 which shows information transmission in the third protocol stack from the top downwards. For clarity's sake, the adaptation module is not shown in the figure and the figure does not mention the header information and the like added by each layer to the received information.

FIG. 5 starts off by the SCCP receiving information 5-1 which indicates that the GT address is to be used in routing. In response to information 5-1, the SCCP transmits in information 5-2 the actual GT address to the SCTP which forwards it to the IP in information 5-3. In the third protocol, the SCCP thus does not perform a GT translation or check what the numbering plan used by the GT address is, but the SCCP is modified to transfer the GT address directly to a lower layer regardless of the numbering plan used. The addressing of the SCCP need not be modified. The IP address is transmitted to the upper layers of the SCCP disguised as an GT address and the actual GT address is transmitted to a protocol of a lower layer.

The information transmission shown in FIGS. 2, 4 and 5 can be associated with the transmission of a called address or a calling address, for instance, and other information than described in FIGS. 2, 4 and 5 can also be transmitted.

FIG. 6 shows a very simplified block diagram of a system 1 according to the first preferred embodiment of the invention without depicting the system architecture and network nodes in more detail, since they are not significant with respect to the invention.

The system in FIG. 6 comprises a network IP using IP technology and having network nodes NE1 and NE1′, and a network SS7 using SS7 technology and having network nodes NE3 and NE3′. The network node NF2 is connected to both networks. In addition, there is a roaming signalling gateway R-SGW between the networks IP and SS7, which, when necessary, translates IP addresses into E-164 addresses and vice versa.

A protocol according to the first or second protocol can be used in all network nodes, though in the IP network nodes NE1 and NE1′, the MTP protocol is unnecessary and correspondingly, in the SS7 network nodes NE3 and NE3′, the SCTP and IP are unnecessary as is the adaptation module when the second protocol is used. It is, therefore, possible to install in them only the part of the first protocol which is necessary. For instance, it is possible to install in the network nodes NE1 and NE1′ an SCCP protocol stack which comprises the following protocols: the SCCP, adaptation layer, SCTP and IP. A corresponding protocol stack can naturally also be installed in the network node NE2.

The network node NE2, which is connected to both networks, can best utilize the first or the second protocol in selecting the network to transfer signalling. In the 3GPP AII-IP network, for instance, such network nodes are the home subscriber server HSS corresponding to the GSM system home location register, the equipment register EIR, and the call state control function CSCF of the 3GPP AII-IP network corresponding to the mobile switching centre MSC and visitor location register VLR of the GSM system. In addition, the first and the second protocol can be used in separate signalling transfer points STP capable of IP/SS7 conversion, such as the R-SGW.

A protocol according to the third protocol can be used in the IP network nodes NE1 and NE1′. A protocol according to the third protocol can also be used in the network node NE2 and in separate signalling transfer points STP capable of IP/SS7 conversion, such as the R-SGW.

The first preferred embodiment of the invention shown in FIG. 6 uses a protocol according to the first protocol in the IP network nodes NE1 and NE1′ and in the network node NE2 connected to both networks. The second preferred embodiment of the invention uses a protocol according to the second protocol in the network nodes NE1, NE1′ and NF2. The first and the second preferred embodiments of the invention provide an advantage that no changes are needed in the existing SS7 network node protocol stacks. Another advantage is that all IP network nodes have the same type of protocol stack. A yet further advantage is that all IP network nodes can, when necessary, also be connected to the SS7 network without protocol updates.

In some other preferred embodiments of the invention, a protocol according to either the first or the second protocol so that the protocol stacks have only the IP stack, not the SS7 stack, or a protocol according to the third protocol is used in the IP network nodes NE1 and NE1′ and NE2. In these preferred embodiments, signalling between the IP network and the SS7 network always goes through a gateway R-SGW, even though the network node NE2 did contain a protocol stack according to the SS7 system.

In some preferred embodiments of the invention, the network nodes NE1 and NE1′ use a protocol according to the third protocol and the network node NE2 uses a protocol according to either the first or the second protocol.

Other preferred embodiments can be created by combining in different ways the above-mentioned protocols of the invention usable in the IP network nodes and/or the protocols of the invention usable in the SS7 network nodes either with each other or with prior art protocols.

Even though in the above, the invention is described assuming that the SCCP protocol stack comprises either the adaptation layer or the adaptation module, it is obvious to a person skilled in the art that the first protocol can be used even when the SCCP protocol stack comprises both the adaptation layer and the adaptation module. The second and the third protocol can be used regardless of whether the SCCP protocol stack comprises the adaptation layer, the adaptation module or both of them.

Even though in the above, the invention is described using the IP system as the second system, it is obvious to a person skilled in the art that it can be used with any system differing from the SS7 system. In the first and the second protocol, it is possible by the new numbering plan value to indicate that the lower layer uses a GT, in which case, depending on the protocol used, the adaptation layer or the SCCP can guide the message to use the correct protocol. There may be several parallel link and transport layer protocols as long each of them has its own numbering plan. In the second protocol some other separator can be used instead of the numbering plan. The SCCP layer according to the third protocol can be used on top of any protocol, because in the third protocol, the GT address is transmitted as such to a lower protocol.

It is to be understood that the above description and the related figures are only intended to illustrate the present invention. Various variations and modifications of the invention will be obvious to a person skilled in the art without departing from the scope and spirit of the invention disclosed in the attached claims.

1. A method for transmitting address information in a telecommunications system protocol stack comprising at least a first layer which comprises an SCCP layer which uses an SCCP protocol according to the SS7 signalling system and a second layer below the first layer, which uses a second protocol according to a second system,
characterized in that the method comprises the following steps:
setting an address according to the second system as a proper address in the address field of the addressing according to the SCCP protocol and marking the address as a global title address of the SCCP protocol, and
transmitting the proper address from the first layer to the second layer.

2. A method as claimed in claim 1, characterized in that the method also comprises the following steps:
indicating the type of the global title address in the SCCP protocol addressing,
checking in the first layer the type of the global title address, and
in response to the global title address according to the second system, transmitting the proper address from the first layer to the second layer.

3. A method as claimed in claim 1, characterized in that the method also comprises the following steps:
indicating the numbering plan used by the global title address in the addressing of the SCCP protocol,
defining for the numbering plan a first value which indicates that the global title address is an address according to the second system,
using in the first layer an adaptation layer below the SCCP layer,
receiving in the SCCP layer from an upper layer a first addressing using the global title address,
performing in the SCCP layer translation of the global title address into a signalling point code,
transmitting from the SCCP layer to the adaptation layer at least the proper address, the value of the numbering plan and the signalling point code,
checking in the adaptation layer the value of the numbering plan, and
in response to the first value of the numbering plan, transmitting the proper address to the second layer.

4. A method as claimed in claim 3, characterized in that the method also comprises the following steps:
defining for the numbering plan at least one second value which indicates that the global title address is an address according to the SS7 signalling system, and
in response to the second value of the numbering plan, transmitting the signalling point code to the second layer.

5. A method as claimed in claim 1, characterized in that the method also comprises the following steps:
indicating the type of the global title address in the SCCP protocol addressing,
using in the first layer an adaptation layer below the SCCP layer,
receiving in the SCCP layer from an upper layer a first addressing using the global title address,
performing in the SCCP layer translation of the global title address into a signalling point code so that the signalling point code indicates the type of the global title address,
transmitting from the SCCP layer to the adaptation layer at least the proper address and the signalling point code,
checking in the adaptation layer the type of the global title address on the basis of the signalling point address, and
in response to an address according to the second system, transmitting the proper address to the second layer.

6. A method as claimed in claim 5, characterized in that in response to an address according to the SS7 system, the method also comprises the step of transmitting the signalling point code to the second layer.

7. A method as claimed in claim 1, characterized in that the method also comprises the following steps:
indicating the type of the global title address in the SCCP protocol addressing,
receiving in th SCCP layer from an upper lay r an addressing using the global title address,
checking in the SCCP layer the type of the global title address, and
in response to an address according to the second system, transmitting the proper address to the second layer.

8. A method as claimed in claim 7, characterized in that in response to an address according to the SS7 signalling system, the method also comprises the following steps:
performing in the SCCP layer translation of the global title address into a signalling point code, and
transmitting the signalling point code to the second layer.

9. A method as claimed in claim 2, 7, or 8 characterized in that the type of the global title address is indicated by the value of the numbering plan.

10. A method as claimed in any one of the preceding claims, characterized in that the second system uses the IP protocol.

11. A telecommunications system network node which is arranged to use in the network layer an SCCP protocol according to the SS7 signalling system and to use below the network layer at least a second protocol according to a second system,
characterized in that the network node (NE1, NE1′, NF2) is arranged to use in the SCCP protocol addressing an address according to the second system as an SCCP protocol global title address and to transmit to the second protocol, the address according to the second system.

12. A network node as claimed in claim 11, characterized in that the network node (NE2)
is arranged to be in contact at least with both a first part of the telecommunications system, which uses the protocol according to the SS7 signalling system below the network layer, and a second part of the telecommunications system which uses the protocol according to the second system below the network layer,
is also arranged to use below the network layer a protocol according to the SS7 signalling system in addition to the second protocol, to identify on the basis of the type of the global title address of the SCCP protocol the protocol of the lower layer, and to select the part of the telecommunications system to be used in routing on the basis of the protocol of the lower layer.

13. A network node as claimed in claim 11 or 12, characterized in that the network node (NE1, NE1′,NE2) is arranged to identify the type of the global title address, and to perform translation of the global title address only if the global title address is an address according to the SS7 signalling system.

14. A network node as claimed in claim 12 or 13, characterized in that the network node (NE1, NE1′, NF2) is arranged to identify the type of the global title address on the basis of the numbering plan conveyd in the addressing of the SCCP protocol.

15. A network node as claimed in claim 12, characterized in that the network node (NE1, NE1′, NP2) is arranged to perform translation of the global title into the signalling point code and to identify the type of the global title address on the basis of the signalling point code.
